(19) United States
(12) Patent Application Publication
(10) Pub. No.: US 2020/0226903 A1
(43) Pub. Date: Jul. 16, 2020

(54) Method and System for Implementing Artificial Intelligence (AI) -Enabled System for Providing Care to Elders, Children, or Patients

(71) Applicant: CenturyLink Intellectual Property LLC, Broomfield, CO (US)

(72) Inventor: Ronald A. Lewis, Bastrop, LA (US)

(21) Appl. No.: 16/363,589

(22) Filed: Mar. 25, 2019

Related U.S. Application Data
(60) Provisional application No. 62/792,512, filed on Jan. 15, 2019.

(51) Int. Cl. G08B 21/04; G08B 21/22; G08B 21/18; G08B 27/00

(52) U.S. Cl. CPC G08B 21/0469; G08B 21/22; G08B 27/005; G08B 21/182; G08B 21/0423

(57) ABSTRACT

Novel tools and techniques are provided for implementing monitoring and provisioning of care to individuals, and, more particularly, to methods, systems, and apparatuses for implementing artificial intelligence (AI)-enabled system for providing care to elders, children, or patients. In various embodiments, a computing system might receive, from a first motion sensor, data regarding monitored one or more first movements of a first individual within a first space; might analyze the received data by comparing the monitored first movements of the first individual with one or more reference movements; might, based on a determination that the monitored first movements of the first individual deviates from the reference movements by a first threshold amount, identify a potential issue associated with a behavior of the first individual; and might, based on the identified potential issue associated with the behavior of the first individual, send an alert indicative of the identified potential issue.

### CROSS-REFERENCES TO RELATED APPLICATIONS

This application claims priority to U.S. patent application Ser. No. 62/792,512 (the “'512 Application”), filed Jan. 15, 2019 by Ronald A. Lewis (attorney docket no. 1524-US-P1), entitled, “Method and System for Implementing Artificial Intelligence (AI)-Enabled System for Providing Care to Elders, Children, or Patients,” the disclosure of which is incorporated herein by reference in its entirety for all purposes.

The respective disclosures of these applications/patents (which this document refers to collectively as the “Related Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing monitoring of and provisioning of care to individuals, and, more particularly, to methods, systems, and apparatuses for implementing artificial intelligence (AI)-enabled system for providing care to elders, children, or patients.

### BACKGROUND

Conventionally, caretaking of elders, children, or patients (collectively, “individuals”) requires constant attention from caretakers or medical professionals, particularly where such individuals have existing physical deficiencies or ailments. Where such individuals are alone (even briefly), such individuals may encounter difficulties (e.g., if the individuals were to fall, or if the individuals behavior are indicative of medical issues, etc.).

The inventor is currently unaware of any non-invasive (non-camera) behavior monitoring systems that monitor movements of the individuals to infer behavior of the individuals, then autonomously compare such behavior with reference behaviors representative of normal behavior of the individual and/or normal behavior of a sample of similar individuals.

Hence, there is a need for more robust and scalable solutions for implementing monitoring of and provisioning of care to individuals, and, more particularly, to methods, systems, and apparatuses for implementing artificial intelligence (AI)-enabled system for providing care to elders, children, or patients.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram illustrating a system for implementing artificial intelligence (AI)-enabled system for providing care to elders, children, or patients, in accordance with various embodiments.

FIG. 2 is a schematic diagram illustrating another system for implementing AI-enabled system for providing care to elders, children, or patients, in accordance with various embodiments.

FIG. 3 is a schematic diagram illustrating customer premises for implementing AI-enabled system for providing care to elders, children, or patients, in accordance with various embodiments.

FIG. 4 is a flow diagram illustrating a method for implementing AI-enabled system for providing care to elders, children, or patients, in accordance with various embodiments.

FIG. 5 is a block diagram illustrating an exemplary computer or system hardware architecture, in accordance with various embodiments.

FIG. 6 is a block diagram illustrating a networked system of computers, computing systems, or system hardware architecture, which can be used in accordance with various embodiments.

### DETAILED DESCRIPTION OF CERTAIN EMBODIMENTS

Overview

Various embodiments provide tools and techniques for implementing monitoring of and provisioning of care to individuals, and, more particularly, to methods, systems, and apparatuses for implementing artificial intelligence (AI)-enabled system for providing care to elders, children, or patients.

In various embodiments, a first motion sensor might monitor one or more first movements of an individual(s) within a first space. The first motion sensor might send data regarding the monitored one or more first movements of the individual(s). In some embodiments, a computing system might receive the data regarding the monitored one or more first movements of the individual(s). The computing system might analyze the received data by comparing the monitored one or more first movements of the individual(s) with one or more reference movements. Based on a determination that the monitored one or more first movements of the individual(s) deviates from the one or more reference movements by a first threshold amount, the computing system might identify a potential issue associated with a behavior of the individual(s). Based on the identified potential issue associated with the behavior of the individual(s), the computing system might send an alert indicative of the identified potential issue associated with the behavior of the individual(s).

In some embodiments, the computing system might include, without limitation, an open source IoT platform, a microcontroller, a server computer over a network, a cloud-based computing system over a network, or a distributed computing system, and/or the like. In some cases, the first motion sensor might include, but is not limited to, one of a wired motion sensor, a wireless motion sensor, a wired infrared (“IR”) sensor, a wireless IR sensor, a wired passive infrared (“PIR”) sensor, or a wireless PIR sensor, and/or the like, where the first motion sensor(s) might be a non-image capture sensor or a non-video capture sensor. In this manner, privacy of the individual(s) may be maintained while monitoring may be implemented to provide care to the individual(s). In some instances, the first motion sensor(s) might output electromagnetic radiation (e.g., IR light, or the like) that bounces off objects or walls within the first space to capture the one or more first movements of the individual(s). According to some embodiments, the first space might include, without limitation, one of a room in a customer premises, a room in a school, a room in a daycare center, a room in a clinic, a room in an urgent care facility, a room in an elder care facility, or a room in a hospital, and/or the like. In some instances, the one or more reference movements might be representative of at least one of normal human behavior or normal behavior for the individual(s).

Merely by way of example, in some cases, the alert indicative of the identified potential issue might comprise one of an actionable alert or a critical alert, and/or the like. The actionable alert might include, without limitation, one or more first actions for inquiring about or checking a status of the individual(s), while the critical alert might include, but is not limited to, one or more second actions for actively aiding the individual(s) due to an urgent status of the individual(s).

According to some embodiments, sending the alert indicative of the identified potential issue associated with the behavior of the individual(s) might comprise sending, with the computing system, an alert indicative of the identified potential issue associated with the behavior of the individual(s) in the form of at least one of a voice interaction with the individual(s) via one or more first speakers, a text message interaction with the individual(s) via a user interface of a first user device associated with the individual(s), a chat interaction with the individual(s) via a user interface of a second user device associated with the individual(s), an automated voice interaction with the individual(s) via a third user device associated with the individual(s), or an e-mail exchange with the individual(s) via a fourth user device associated with the individual(s), and/or the like. In some embodiments, the individual(s) might include, but is not limited to, one of an elder, a child, or a patient, and/or the like.

Alternatively, or additionally, sending the alert indicative of the identified potential issue associated with the behavior of the individual(s) might comprise sending, with the computing system, an alert indicative of the identified potential issue associated with the behavior of the individual(s) in the form of at least one of a voice interaction with a caretaker of the individual(s) via one or more second speakers, a text message interaction with the caretaker of the individual(s) via a user interface of a first user device associated with the caretaker, a chat interaction with the caretaker of the individual(s) via a user interface of a second user device associated with the caretaker, an automated voice interaction with the caretaker of the individual(s) via a third user device associated with the caretaker, an e-mail exchange with the caretaker of the individual(s) via a fourth user device associated with the caretaker, a voice interaction with a medical professional providing medical care to the individual(s) via one or more third speakers, a text message interaction with the medical professional providing medical care to the individual(s) via a user interface of a first user device associated with the medical professional, a chat interaction with the medical professional providing medical care to the individual(s) via a user interface of a second user device associated with the medical professional, an automated voice interaction with the medical professional providing medical care to the individual(s) via a third user device associated with the medical professional, or an e-mail exchange with the medical professional providing medical care to the individual(s) via a fourth user device associated with the medical professional, and/or the like. In some embodiments, the caretaker might include, without limitation, one of a nurse, an elder care facility staff member, or a family member of the individual(s), and/or the like. According to some embodiments, the medical professional might include, but is not limited to, one of a doctor, a physician's assistant, a nurse, a midwife, a pharmacist, a surgeon, psychiatrist, a psychologist, a chiropractor, or a dentist, and/or the like.

In some embodiments, at least one of the data regarding the monitored one or more first movements of the individual(s) or data regarding the one or more reference movements might be stored in and accessible from a database. According to some embodiments, the database might include, without limitation, at least one of a local database, a network database accessible by the computing system via a network, or a cloud database, and/or the like.

Unlike conventional provision of care systems and implementations, the various embodiments provide for a non-invasive (i.e., non-camera) behavior monitoring systems that monitor movements of the individuals (while preserving privacy of the individuals) to infer behavior of the individuals, then autonomously compares such behavior with reference behaviors representative of normal behavior of the individual and/or normal behavior of a sample of similar individuals. The system also determines whether deviations from the norm trigger actionable or critical events, and will act accordingly to check on the individuals and/or alert family members, caretakers, and/or medical professionals to address physical and/or medical issues encountered by the individuals.

These and other aspects of the monitoring of and provisioning of care to individuals are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments described herein, while embodying (in some cases) software products, computer-performed methods, and/or computer systems, represent tangible, concrete improvements to existing technological areas, including, without limitation, home security technology, business security technology, human monitoring technology, human behavior analysis technology, and/or the like. In other aspects, certain embodiments, can improve the functioning of user equipment or systems themselves (e.g., home security systems, business security systems, human monitoring systems, human behavior analysis systems, etc.), for example, by monitoring, with a first motion sensor, one or more first movements of a first individual within a first space; sending, with the first motion sensor, data regarding the monitored one or more first movements of the first individual; receiving, with a computing system, the data regarding the monitored one or more first movements of the first individual; analyzing, with the computing system, the received data by comparing the monitored one or more first movements of the first individual with one or more reference movements; based on a determination that the monitored one or more first movements of the first individual deviates from the one or more reference movements by a first threshold amount, identifying, with the computing system, a potential issue associated with a behavior of the first individual; and based on the identified potential issue associated with the behavior of the first individual, sending, with the computing system, an alert indicative of the identified potential issue associated with the behavior of the first individual; and/or the like. In particular, to the extent any abstract concepts are present in the various embodiments, those concepts can be implemented as described herein by devices, software, systems, and methods that involve specific novel functionality (e.g., steps or operations), such as, monitoring movements of an individual using motion sensors, analyzing data regarding the monitored movements of the individual by comparing the monitored movements of the individual with reference movements, based on a determination that the monitored one or more first movements of the first individual deviates from the one or more reference movements by a first threshold amount, identifying a potential issue associated with a behavior of the first individual, and based on the identified potential issue associated with the behavior of the first individual, sending an alert indicative of the identified potential issue associated with the behavior of the first individual, and/or the like, to name a few examples, that extend beyond mere conventional computer processing operations. These functionalities can produce tangible results outside of the implementing computer system, including, merely by way of example, optimized, automated monitoring and provisioning of care to individuals (e.g., elders, children, or patients), and/or the like, at least some of which may be observed or measured by customers and/or service providers.

In an aspect, a method might comprise monitoring, with a first motion sensor, one or more first movements of a first individual within a first space; and sending, with the first motion sensor, data regarding the monitored one or more first movements of the first individual. The method might also comprise receiving, with a computing system, the data regarding the monitored one or more first movements of the first individual; and analyzing, with the computing system, the received data by comparing the monitored one or more first movements of the first individual with one or more reference movements. The method might further comprise, based on a determination that the monitored one or more first movements of the first individual deviates from the one or more reference movements by a first threshold amount, identifying, with the computing system, a potential issue associated with a behavior of the first individual; and based on the identified potential issue associated with the behavior of the first individual, sending, with the computing system, an alert indicative of the identified potential issue associated with the behavior of the first individual.

In some embodiments, the computing system might comprise at least one of an open source IoT platform, a microcontroller, a server computer over a network, a cloud-based computing system over a network, or a distributed computing system, and/or the like. In some cases, the first motion sensor might comprise one of a wired motion sensor, a wireless motion sensor, a wired infrared (“IR”) sensor, a wireless IR sensor, a wired passive infrared (“PIR”) sensor, or a wireless PR sensor, and/or the like, where the first motion sensor(s) might be a non-image capture sensor or a non-video capture sensor. In this manner, privacy of the first individual may be maintained while monitoring may be implemented to provide care to the first individual. In some instances, the first motion sensor(s) might output electromagnetic radiation (e.g., IR light, or the like) that bounces off objects or walls within the first space to capture the one or more first movements of the first individual. According to some embodiments, the first space might comprise one of a room in a customer premises, a room in a school, a room in a daycare center, a room in a clinic, a room in an urgent care facility, a room in an elder care facility, or a room in a hospital, and/or the like. In some instances, the one or more reference movements might be representative of at least one of normal human behavior or normal behavior for the first individual.

Merely by way of example, in some cases, the alert indicative of the identified potential issue might comprise one of an actionable alert or a critical alert, and/or the like. The actionable alert might comprise one or more first actions for inquiring about or checking a status of the first individual, while the critical alert might include, but is not limited to, one or more second actions for actively aiding the first individual due to an urgent status of the first individual.

According to some embodiments, sending the alert indicative of the identified potential issue associated with the behavior of the first individual might comprise sending, with the computing system, an alert indicative of the identified potential issue associated with the behavior of the first individual in the form of at least one of a voice interaction with the first individual via one or more first speakers, a text message interaction with the first individual via a user interface of a first user device associated with the first individual, a chat interaction with the first individual via a user interface of a second user device associated with the first individual, an automated voice interaction with the first individual via a third user device associated with the first individual, or an e-mail exchange with the first individual via a fourth user device associated with the first individual, and/or the like. In some embodiments, the first individual might comprise one of an elder, a child, or a patient, and/or the like.

Alternatively, or additionally, sending the alert indicative of the identified potential issue associated with the behavior of the first individual might comprise sending, with the computing system, an alert indicative of the identified potential issue associated with the behavior of the first individual in the form of at least one of a voice interaction with a caretaker of the first individual via one or more second speakers, a text message interaction with the caretaker of the first individual via a user interface of a first user device associated with the caretaker, a chat interaction with the caretaker of the first individual via a user interface of a second user device associated with the caretaker, an automated voice interaction with the caretaker of the first individual via a third user device associated with the caretaker, an e-mail exchange with the caretaker of the first individual via a fourth user device associated with the caretaker, a voice interaction with a medical professional providing medical care to the first individual via one or more third speakers, a text message interaction with the medical professional providing medical care to the first individual via a user interface of a first user device associated with the medical professional, a chat interaction with the medical professional providing medical care to the first individual via a user interface of a second user device associated with the medical professional, an automated voice interaction with the medical professional providing medical care to the first individual via a third user device associated with the medical professional, or an e-mail exchange with the medical professional providing medical care to the first individual via a fourth user device associated with the medical professional, and/or the like. In some embodiments, the caretaker might include, without limitation, one of a nurse, an elder care facility staff member, or a family member of the first individual, and/or the like. According to some embodiments, the medical professional might include, but is not limited to, one of a doctor, a physician's assistant, a nurse, a midwife, a pharmacist, a surgeon, psychiatrist, a psychologist, a chiropractor, or a dentist, and/or the like.

In some embodiments, at least one of the data regarding the monitored one or more first movements of the first individual or data regarding the one or more reference movements might be stored in and accessible from a database. According to some embodiments, the database might comprise at least one of a local database, a network database accessible by the computing system via a network, or a cloud database, and/or the like.

In another aspect, an apparatus might comprise at least one processor and a non-transitory computer readable medium communicatively coupled to the at least one processor. The non-transitory computer readable medium might have stored thereon computer software comprising a set of instructions that, when executed by the at least one processor, causes the apparatus to: receive, from a first motion sensor, data regarding monitored one or more first movements of a first individual within a first space; analyze the received data by comparing the monitored one or more first movements of the first individual with one or more reference movements; based on a determination that the monitored one or more first movements of the first individual deviates from the one or more reference movements by a first threshold amount, identify a potential issue associated with a behavior of the first individual; and based on the identified potential issue associated with the behavior of the first individual, send an alert indicative of the identified potential issue associated with the behavior of the first individual.

In some embodiments, the first motion sensor might comprise one of a wired motion sensor, a wireless motion sensor, a wired infrared (“IR”) sensor, a wireless IR sensor, a wired passive infrared (“PIR”) sensor, or a wireless PIR sensor, and/or the like, wherein the first motion sensor is a non-image capture sensor or a non-video capture sensor. In some cases, the first space might comprise one of a room in a customer premises, a room in a school, a room in a daycare center, a room in a clinic, a room in an urgent care facility, a room in an elder care facility, or a room in a hospital, and/or the like. In some instances, the one or more reference movements might be representative of at least one of normal human behavior or normal behavior for the first individual. In some cases, the alert indicative of the identified potential issue might comprise one of an actionable alert or a critical alert, wherein the actionable alert might comprise one or more first actions for inquiring about or checking a status of the first individual, wherein the critical alert might comprise one or more second actions for actively aiding the first individual due to an urgent status of the first individual. According to some embodiments, at least one of the data regarding the monitored one or more first movements of the first individual or data regarding the one or more reference movements might be stored in and accessible from a database.

In yet another aspect, a system might comprise a first motion sensor and a computing system. The computing system might comprise at least one processor and a non-transitory computer readable medium communicatively coupled to the at least one processor. The non-transitory computer readable medium might have stored thereon computer software comprising a set of instructions that, when executed by the at least one processor, causes the computing system to: receive, from a first motion sensor, data regarding monitored one or more first movements of a first individual within a first space; analyze the received data by comparing the monitored one or more first movements of the first individual with one or more reference movements; based on a determination that the monitored one or more first movements of the first individual deviates from the one or more reference movements by a first threshold amount, identify a potential issue associated with a behavior of the first individual; and based on the identified potential issue associated with the behavior of the first individual, send an alert indicative of the identified potential issue associated with the behavior of the first individual.

In some embodiments, the computing system might comprise at least one of an open source IoT platform, a microcontroller, a server computer over a network, a cloud-based computing system over a network, or a distributed computing system, and/or the like. In some cases, the first motion sensor comprises one of a wired motion sensor, a wireless motion sensor, a wired infrared (“IR”) sensor, a wireless IR sensor, a wired passive infrared (“PIR”) sensor, or a wireless PIR sensor, and/or the like, wherein the first motion sensor is a non-image capture sensor or a non-video capture sensor.

Various modifications and additions can be made to the embodiments discussed without departing from the scope of the invention. For example, while the embodiments described above refer to particular features, the scope of this invention also includes embodiments having different combination of features and embodiments that do not include all of the above described features.

Specific Exemplary Embodiments

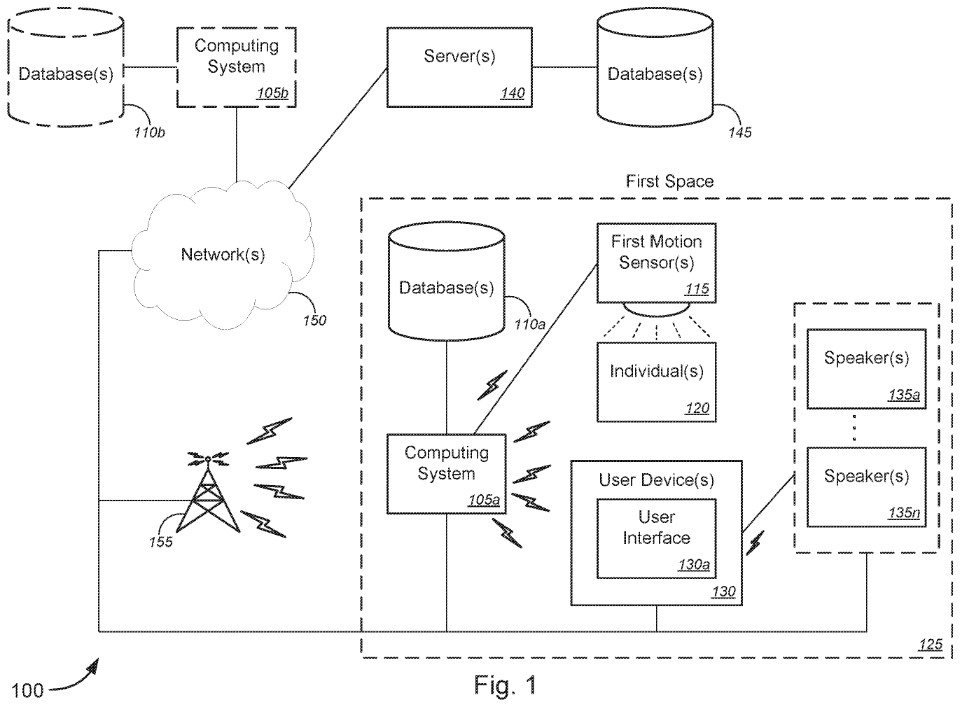

We now turn to the embodiments as illustrated by the drawings. FIGS. 1-6 illustrate some of the features of the method, system, and apparatus for implementing monitoring of and provisioning of care to individuals, and, more particularly, to methods, systems, and apparatuses for implementing artificial intelligence (AI)-enabled system for providing care to elders, children, or patients, as referred to above. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

With reference to the figures, FIG. 1 is a schematic diagram illustrating a system 100 for implementing artificial intelligence (AI)-enabled system for providing care to elders, children, or patients, in accordance with various embodiments.

In the non-limiting embodiment of FIG. 1, system 100 might comprise a computing system 105a and a data store or database 110a that is local to the computing system 105a. In some cases, the database 110a might be external, yet communicatively coupled, to the computing system 105a. In other cases, the database 110a might be integrated within the computing system 105a. System 100, according to some embodiments, might further comprise one or more first motion sensors 115, which might be used to monitor movements of an individual(s) 120 within a first space 125, which might include, without limitation, one of a room in a customer premises, a room in a school, a room in a daycare center, a room in a clinic, a room in an urgent care facility, a room in an elder care facility, or a room in a hospital, and/or the like. The system 100 might further comprise a user device(s) 130 associated with the individual(s) 120, where the user device(s) 130 might each comprise a user interface 130a, or the like. In some embodiments, the user device(s) 130 might each include, but is not limited to, one of a laptop computer, a desktop computer, a tablet computer, a smart phone, a mobile phone, a personal digital assistant, a remote control device, a portable gaming device, a television, a monitor, a speaker, a smart home appliance, and/or the like. The system 100 might further comprise one or more speakers 135a-135n (collectively, “speakers 135” or the like). The computing system 105a might communicatively couple (via wired and/or wireless links) with the database(s) 110a and the first motion sensor(s) 115, and might, in some cases, also communicatively couple (via wired and/or wireless links) with the user device(s) 130 and/or the speaker(s) 135.

According to some embodiments, system 100 might further comprise a remote computing system 105b (optional) and corresponding database(s) 110b (optional), a server(s) 140 and corresponding database(s) 145, and network(s) 150. The remote computing system 105b and corresponding database(s) 110b might function in a similar manner as computing system 105a and corresponding database(s) 110a, except that remote computing system 105b and corresponding database(s) 110b are remotely located with respect to the first space 125. Accordingly, the computing system 105b might communicatively couple (via wired and/or wireless links) with the database(s) 110b and the first motion sensor(s) 115, and might, in some cases, also communicatively couple (via wired and/or wireless links) with the user device(s) 130 and/or the speaker(s) 135, and both cases via network(s) 150 and one or more telecommunications relay systems 155. The one or more telecommunications relay systems 155 might include, without limitation, one or more wireless network interfaces (e.g., wireless modems, wireless access points, and the like), one or more towers, one or more satellites, and/or the like). The lightning bolt symbols are used to denote wireless communications between the one or more telecommunications relay systems 155 and the computing system 105a, between the one or more telecommunications relay systems 155 and the first motion sensor(s) 115, between the one or more telecommunications relay systems 155 and each of at least one of the user devices 130, between the computing system 105a and the first motion sensor(s) 115, between the computing system 105a and each of at least one of the user device(s) 130, between the computing system 105a and each of the one or more speakers 135a-135n, between the user device(s) 130 and each of the one or more speakers 135a-135n, and/or the like.

In some instances, the network(s) 150 can each include a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network 150 might include an access network of the service provider (e.g., an Internet service provider (“ISP”)). In another embodiment, the network 150 might include a core network of the service provider, and/or the Internet.

In some embodiments, the computing system 105a or 105b might include, without limitation, at least one of an open source IoT platform, a microcontroller, a server computer 140 over a network (e.g., network 150, or the like), a cloud-based computing system over a network (e.g., network 150, or the like), or a distributed computing system, and/or the like. In some instances, the microcontroller might include a NodeMCU microcontroller or the like, and which, in some cases, might be an artificial intelligence enabled controller functioning as both web server and web client. The microcontroller might collect the data from the PR sensor(s) via the web server over WiFi (or the like) to capture behavior and push the data into a cloud-based database. The NodeMCU can interact with smart speakers or the like to allow someone to call out for help via voice control or the like.

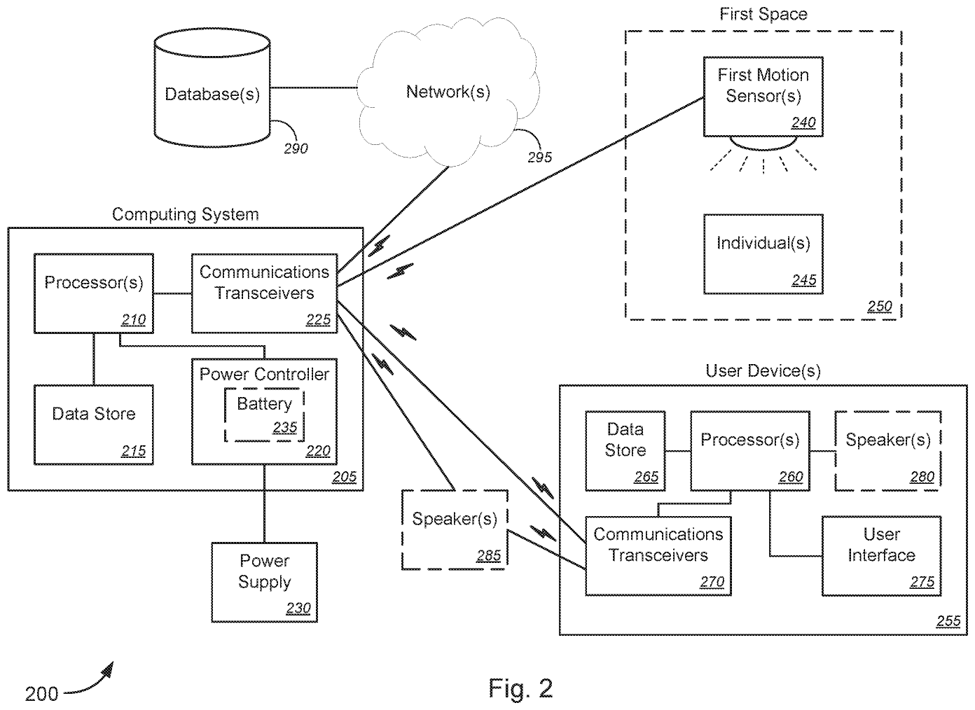

In some cases, the first motion sensor(s) 115 might include, but is not limited to, one of a wired motion sensor, a wireless motion sensor, a wired infrared (“IR”) sensor, a wireless IR sensor, a wired passive infrared (“PIR”) sensor, or a wireless PIR sensor, and/or the like, where the first motion sensor(s) 115 might be a non-image capture sensor or a non-video capture sensor. In this manner, privacy of the individual(s) may be maintained while monitoring may be implemented to provide care to the individual(s). In some instances, the first motion sensor(s) 115 might output electromagnetic radiation (e.g., IR light (as illustrated by radiating short dash lines extending from a curved surface of the first motion sensor(s) 240 as shown FIG. 2, or the like), or the like) that bounces off objects or walls within the first space 125 to capture the one or more first movements of the individual(s) 120. According to some embodiments, the PIR sensor might be a passive infrared sensor that bounces IR light off objects, and allows the system to capture movement that may be equated or correlated with behavior.

In operation, the first motion sensor(s) 115 might monitor one or more first movements of the individual(s) 120 within the first space 125. The first motion sensor(s) 115 might send data regarding the monitored one or more first movements of the individual(s) 120. In some embodiments, at least one of the computing system 105a or 105b and/or the server(s) 140 (collectively, “computing system” or the like) might receive the data regarding the monitored one or more first movements of the individual(s) 120. The computing system might analyze the received data by comparing the monitored one or more first movements of the individual(s) 120 with one or more reference movements. Based on a determination that the monitored one or more first movements of the individual(s) 120 deviates from the one or more reference movements by a first threshold amount, the computing system might identify a potential issue associated with a behavior of the individual(s) 120. In some instances, the one or more reference movements might be representative of at least one of normal human behavior or normal behavior for the individual(s) 120. Based on the identified potential issue associated with the behavior of the individual(s) 120, the computing system might send an alert indicative of the identified potential issue associated with the behavior of the individual(s) 120.

In some aspects, statistical analysis may be used to determine the monitored one or more first movements of the individual(s) 120 deviates from the one or more reference movements by the first threshold amount. In some cases, data might be stored in a cloud-based database. The data might be mined for deviations from normal behavior. Deviations may be assessed against distance from the mean and evaluated as actionable or critical. For example, if the first motion sensor(s) 115 (e.g., PIR sensors) notices movement on the floor of a room and the size is the same as a home occupant (e.g., individual(s) 120), the system can determine based on rate of movement whether the individual(s) 120 has fallen or if the individual(s) 120 (based on rate of movement and normal behavior) is simply exercising (e.g., doing pushups, crunches, or the like). If the system determines that the individual(s) 120 has fallen, a critical event may be triggered and emergency personnel may be alerted. In another example, if the individual(s) 120 has entered a bedroom and has not left the bedroom for hours equal to one standard deviation from the norm (i.e., normal behavior of the individual and/or normal behavior of a sample of similar individuals, etc.), an actionable event may be triggered, and a third party may be notified to check on the individual(s) 120. If the system determines that the behavior of the individual(s) 120 equals two or more standard deviations from the norm (i.e., normal behavior of the individual and/or normal behavior of a sample of similar individuals, etc.), a critical event may be triggered and emergency personnel should be notified. In another non-limiting example, one linear set of values might depict the number of times a typical 50 year old male goes to the bathroom per hour (which might be deemed normal human behavior). A second linear set more specifically depicts the number of times that this particular 50 year old male goes to the bathroom per hour (normal individual behavior). The system 100 (e.g., the computing system 105a or 105b, or the like) might measure long term trends against normal human behavior, while guiding sending of the alert based on individual norms. In such cases, using the number of deviations from the norm (along with correlation to a risk matrix—e.g., even if it is normal for the particular 50 year old male to go to the bathroom once per hour, if a first standard deviation is 1 time per hour—the system might still alert emergency responders if the person goes to the bathroom 1.5 times per hour) to determine criticality of the event. In yet another non-limiting example, one linear set of values might depict the number of hours a typical 40 year old female sleeps per night (which might be deemed normal human behavior). A second linear set more specifically depicts the number of times that this particular 40 year old female sleeps per night (normal individual behavior). The system 100 (e.g., the computing system 105a or 105b, or the like) might measure long term trends against normal human behavior, while guiding sending of the alert based on individual norms. In such cases, using the number of deviations from the norm (along with correlation to a risk matrix—e.g., even if it is normal for the particular 40 year old female to stay in bed 11 hours a day, if a first standard deviation is 14 hours—still should probably alert emergency responders if the person has not gotten out of bed in 14 hours) to determine criticality of the event.

In some embodiments, voice recognition integration may be implemented. For instance, at least one of the speakers 135 may include microphones that may be used to pick up voice commands or vocalizations from the individual(s) 120 (e.g., “I need help!” or “Help me!” or the like). The computing system 105 might receive the voice commands or vocalizations from the individual(s) 120 and might determine whether to dial 911 or specific phone number to family members, caretakers, and/or medical professionals (e.g., “third parties”), and may also provide such third parties with location information, and/or may provide direct voice communication between the individual(s) 120 and the third parties, e.g., for actionable and/or critical events.

According to some embodiments, artificial intelligence (“AI”) integration may be implemented in a cloud computing system. An AI microcontroller (such as computing system 105a or 105b) might be trained to raise critical events and might turn on voice over Internet protocol (“VoIP”) devices. The actual human/AI integration might be performed in the cloud via an AI server (where server(s) 140, in some cases, might comprise such an AI server). The AI server might evaluate the intents of responses and might form an adequate response based on the ontology describing the necessary actions for handling the event (either critical or actionable).

In some embodiments, the first motion sensor(s) 115 might utilize wireless PIR sensors that are part of existing home or business security solutions. In some cases, the microcontroller (e.g., computing system 105a) might be integrated with the existing security alarm controller of the existing home or business security solutions to pull motion data from existing motion sensors. In some instances, the system can use cellular backhaul or the like provided with existing solutions or can use WiFi in the home.

Merely by way of example, in some cases, the alert indicative of the identified potential issue might comprise one of an actionable alert or a critical alert, and/or the like. The actionable alert might include, without limitation, one or more first actions for inquiring about or checking a status of the individual(s) 120, while the critical alert might include, but is not limited to, one or more second actions for actively aiding the individual(s) 120 due to an urgent status of the individual(s) 120.

According to some embodiments, sending the alert indicative of the identified potential issue associated with the behavior of the individual(s) 120 might comprise sending, with the computing system 105a or 105b, an alert indicative of the identified potential issue associated with the behavior of the individual(s) 120 in the form of at least one of a voice interaction with the individual(s) 120 via one or more first speakers 135a-135n, a text message interaction with the individual(s) 120 via a user interface 130a of a first user device 130 associated with the individual(s) 120, a chat interaction with the individual(s) 120 via a user interface 130a of a second user device 130 associated with the individual(s) 120, an automated voice interaction with the individual(s) 120 via a third user device 130 associated with the individual(s) 120, or an e-mail exchange with the individual(s) 120 via a fourth user device 130 associated with the individual(s) 120, and/or the like. In some cases, at least two of the first user device, the second user device, the third user device, or the fourth user device are the same user device. In some embodiments, the individual(s) 120 might include, but is not limited to, one of an elder, a child, or a patient, and/or the like.

Alternatively, or additionally, sending the alert indicative of the identified potential issue associated with the behavior of the individual(s) 120 might comprise sending, with the computing system 105a or 105b, an alert indicative of the identified potential issue associated with the behavior of the individual(s) 120 in the form of at least one of a voice interaction with a caretaker (not shown) of the individual(s) 120 via one or more second speakers, a text message interaction with the caretaker of the individual(s) 120 via a user interface of a first user device associated with the caretaker, a chat interaction with the caretaker of the individual(s) 120 via a user interface of a second user device associated with the caretaker, an automated voice interaction with the caretaker of the individual(s) 120 via a third user device associated with the caretaker, an e-mail exchange with the caretaker of the individual(s) 120 via a fourth user device associated with the caretaker, a voice interaction with a medical professional (not shown) providing medical care to the individual(s) 120 via one or more third speakers, a text message interaction with the medical professional providing medical care to the individual(s) 120 via a user interface of a first user device associated with the medical professional, a chat interaction with the medical professional providing medical care to the individual(s) 120 via a user interface of a second user device associated with the medical professional, an automated voice interaction with the medical professional providing medical care to the individual(s) 120 via a third user device associated with the medical professional, or an e-mail exchange with the medical professional providing medical care to the individual(s) 120 via a fourth user device associated with the medical professional, and/or the like. In some embodiments, the caretaker might include, without limitation, one of a nurse, an elder care facility staff member, or a family member of the individual(s) 120, and/or the like. According to some embodiments, the medical professional might include, but is not limited to, one of a doctor, a physician's assistant, a nurse, a midwife, a pharmacist, a surgeon, psychiatrist, a psychologist, a chiropractor, or a dentist, and/or the like.

In some embodiments, at least one of the data regarding the monitored one or more first movements of the individual(s) 120 or data regarding the one or more reference movements might be stored in and accessible from a database. According to some embodiments, the database might include, without limitation, at least one of a local database 110a, a network database 110b or 145 accessible by the computing system 105a or 105b via a network, or a cloud database 110b or 145, and/or the like.

These and other functions of the system 100 (and its components) are described in greater detail below with respect to FIGS. 2-4.

FIG. 2 is a schematic diagram illustrating another system 200 for implementing AI-enabled system for providing care to elders, children, or patients, in accordance with various embodiments.

In the non-limiting embodiment of FIG. 2, system 200 might comprise a computer system 205, which might comprise a processor(s) 210, a data store 215, a power controller 220, and communications transceivers 225. In some embodiments, the system might further comprise a power supply 230, which might supply electrical power to the computing system 205 via power controller 220, when the power supply 230 is electrically connected to computing system 205. Alternative or additional to the power supplied by the power supply 230, the power controller 220 might comprise a battery 235 that might also supply the electrical power to the computing system 205.

According to some embodiments, the computing system 205 might include, without limitation, at least one of an open source IoT platform, a microcontroller, a server computer over a network, a cloud-based computing system over a network, or a distributed computing system, and/or the like. In some instances, the microcontroller might include a NodeMCU microcontroller or the like, and which, in some cases, might be an artificial intelligence enabled controller functioning as both web server and web client. The microcontroller might collect the data from PIR sensor(s) or the like via the web server over WiFi (or the like) to capture behavior and push the data into a cloud-based database. The NodeMCU can interact with smart speakers or the like to allow someone to call out for help via voice control or the like. In some cases, the power supply 230 might include a power adapter (e.g., a 5V adapter, or the like), an electrical outlet, a universal serial bus (“USB”) port, and the like. In some instances, the power controller 220 might be a controller that allows connection with a battery backup capability (i.e., connection with battery 235, or the like) in case of power loss on the master unit due to disconnection between the computing system 205 and the power supply 230.

In some embodiments, system 200 might further comprise one or more first motion sensors 240, which might be used to monitor movements of an individual(s) 245 within a first space 250. The first space 250 might include, without limitation, one of a room in a customer premises, a room in a school, a room in a daycare center, a room in a clinic, a room in an urgent care facility, a room in an elder care facility, or a room in a hospital, and/or the like.

In some cases, the first motion sensor(s) 240 might include, but is not limited to, one of a wired motion sensor, a wireless motion sensor, a wired infrared (“IR”) sensor, a wireless IR sensor, a wired passive infrared (“PIR”) sensor, or a wireless PIR sensor, and/or the like, where the first motion sensor(s) 240 might be a non-image capture sensor or a non-video capture sensor. In this manner, privacy of the individual(s) may be maintained while monitoring may be implemented to provide care to the individual(s). In some instances, the first motion sensor(s) 240 might output electromagnetic radiation (e.g., IR light (as illustrated by radiating short dash lines extending from a curved surface of the first motion sensor(s) 240 as shown FIG. 2, or the like), or the like) that bounces off objects or walls within the first space 250 to capture the one or more first movements of the individual(s) 245. According to some embodiments, the PIR sensor might be a passive infrared sensor that bounces IR light off objects, and allows the system to capture movement that may be equated or correlated with behavior.

According to some embodiments, system 200 might further comprise one or more user devices 255, each of which might comprise a processor(s) 260, a data store 265, communications transceivers 270, a user interface 275, and one or more internal or built-in speakers 280 (optional). In some embodiments, the user device(s) 255 might each include, but is not limited to, one of a laptop computer, a desktop computer, a tablet computer, a smart phone, a mobile phone, a personal digital assistant, a remote control device, a portable gaming device, a television, a monitor, a speaker, a smart home appliance, and/or the like.

In some cases, the system 200 might further comprise one or more external speakers 285 (optional). According to some embodiments, the system 200 might further comprise one or more databases 290 and network(s) 295. In some instances, the network(s) 295 can each include a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network 295 might include an access network of the service provider (e.g., an Internet service provider (“ISP”)). In another embodiment, the network 295 might include a core network of the service provider, and/or the Internet. The lightning bolt symbols are used to denote wireless communications between the communications transceivers 225 of the computing system 205 and the first motion sensor(s) 240, between the communications transceivers 225 of the computing system 205 and the communications transceivers 270 of the user devices 255, between the communications transceivers 225 of the computing system 205 and speaker(s) 285 (optional), between the communications transceivers 225 of the computing system 205 and network(s) 295 (or database(s) 290 via network(s) 295), between the communications transceivers 270 of the user device(s) 255 and speaker(s) 285 (optional), and/or the like.

In operation, the first motion sensor(s) 240 might monitor one or more first movements of the individual(s) 245 within the first space 250. The first motion sensor(s) 240 might send data regarding the monitored one or more first movements of the individual(s) 245. In some embodiments, at least one of the computing system 205 might receive the data regarding the monitored one or more first movements of the individual(s) 245. The computing system 205 might analyze the received data by comparing the monitored one or more first movements of the individual(s) 245 with one or more reference movements. Based on a determination that the monitored one or more first movements of the individual(s) 245 deviates from the one or more reference movements by a first threshold amount, the computing system 205 might identify a potential issue associated with a behavior of the individual(s) 245. In some instances, the one or more reference movements might be representative of at least one of normal human behavior or normal behavior for the individual(s) 245. Based on the identified potential issue associated with the behavior of the individual(s) 245, the computing system 205 might send an alert indicative of the identified potential issue associated with the behavior of the individual(s) 245.

Merely by way of example, in some cases, the alert indicative of the identified potential issue might comprise one of an actionable alert or a critical alert, and/or the like. The actionable alert might include, without limitation, one or more first actions for inquiring about or checking a status of the individual(s) 245, while the critical alert might include, but is not limited to, one or more second actions for actively aiding the individual(s) 245 due to an urgent status of the individual(s) 245.

According to some embodiments, sending the alert indicative of the identified potential issue associated with the behavior of the individual(s) 245 might comprise sending, with the computing system 205, an alert indicative of the identified potential issue associated with the behavior of the individual(s) 245 in the form of at least one of a voice interaction with the individual(s) 245 via one or more first speakers 280 or 285, a text message interaction with the individual(s) 245 via a user interface 275 of a first user device 255 associated with the individual(s) 245, a chat interaction with the individual(s) 245 via a user interface 275 of a second user device 255 associated with the individual(s) 245, an automated voice interaction with the individual(s) 245 via a third user device 255 associated with the individual(s) 245, or an e-mail exchange with the individual(s) 245 via a fourth user device 255 associated with the individual(s) 245, and/or the like. In some cases, at least two of the first user device, the second user device, the third user device, or the fourth user device are the same user device. In some embodiments, the individual(s) 245 might include, but is not limited to, one of an elder, a child, or a patient, and/or the like.

Alternatively, or additionally, sending the alert indicative of the identified potential issue associated with the behavior of the individual(s) 245 might comprise sending, with the computing system 205, an alert indicative of the identified potential issue associated with the behavior of the individual(s) 245 in the form of at least one of a voice interaction with a caretaker (not shown) of the individual(s) 245 via one or more second speakers, a text message interaction with the caretaker of the individual(s) 245 via a user interface of a first user device associated with the caretaker, a chat interaction with the caretaker of the individual(s) 245 via a user interface of a second user device associated with the caretaker, an automated voice interaction with the caretaker of the individual(s) 245 via a third user device associated with the caretaker, an e-mail exchange with the caretaker of the individual(s) 245 via a fourth user device associated with the caretaker, a voice interaction with a medical professional (not shown) providing medical care to the individual(s) 245 via one or more third speakers, a text message interaction with the medical professional providing medical care to the individual(s) 245 via a user interface of a first user device associated with the medical professional, a chat interaction with the medical professional providing medical care to the individual(s) 245 via a user interface of a second user device associated with the medical professional, an automated voice interaction with the medical professional providing medical care to the individual(s) 245 via a third user device associated with the medical professional, or an e-mail exchange with the medical professional providing medical care to the individual(s) 245 via a fourth user device associated with the medical professional, and/or the like. In some embodiments, the caretaker might include, without limitation, one of a nurse, an elder care facility staff member, or a family member of the individual(s) 245, and/or the like. According to some embodiments, the medical professional might include, but is not limited to, one of a doctor, a physician's assistant, a nurse, a midwife, a pharmacist, a surgeon, psychiatrist, a psychologist, a chiropractor, or a dentist, and/or the like.

In some embodiments, at least one of the data regarding the monitored one or more first movements of the individual(s) 245 or data regarding the one or more reference movements might be stored in and accessible from a database. According to some embodiments, the database might include, without limitation, at least one of a local database 215, a network database 290 accessible by the computing system 205 via a network, or a cloud database 290, and/or the like.

The computing system 205, the first motion sensor(s) 240, the individual(s) 245, the user device(s) 255, the speaker(s) 280 or 285, the database(s) 290, and the network(s) 295 of system 200 of FIG. 2 might be otherwise similar, if not identical, to the computing system 105a or 105b, the first motion sensor(s) 115, the individual(s) 120, the user device(s) 130, the speaker(s) 135a-135n, the database(s) 110a, 110b, or 145, and the network(s) 150, respectively, of system 100 of FIG. 1, or the like, and the descriptions of these components of system 100 are applicable to the corresponding components of system 200, respectively.

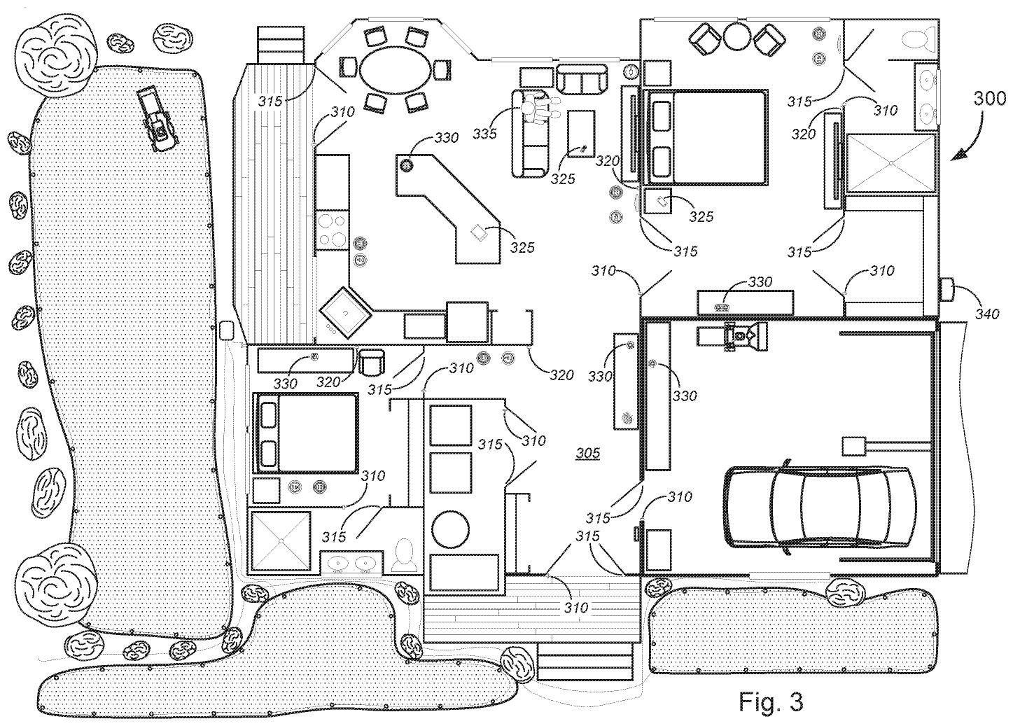

FIG. 3 is a schematic diagram illustrating customer premises 300 for implementing AI-enabled system for providing care to elders, children, or patients, in accordance with various embodiments.

With reference to FIG. 3, a customer premises 300 (although shown in FIG. 3 as a ranch-style residential home) might comprise a home, building, or other customer premises structure (e.g., business premises, commercial office, school, industrial building, etc.) 305, in which might comprise one or more pieces of furniture (including, but not limited to, dining tables, dining chairs, couches or sofas, side tables, coffee tables, entertainment stands, beds, seats, dressers, cabinets, shelves, stools, etc.), home appliances or fixtures (including, without limitation, kitchen sinks, bathroom sinks, toilets, shower enclosures, bathtubs, smoke detectors, CO monitors, home/business/premises security systems, thermostat, mirrors, lights, furnace, air conditioner, water heater, washer, dryer, garage door opener, etc.), user or electronic devices (including, but not limited to, televisions, smart phones, mobile phones, tablet computers, desktop computers, set-top boxes (“STBs”), gaming devices or consoles, virtual reality goggles, augmented reality goggles, etc.), kitchen appliances (including, without limitation, electric stoves, induction stoves, gas stoves, refrigerators, freezers, microwave ovens, electric ovens, convectional ovens, gas ovens, rice cookers, steamers, coffee machines, tea machines, toasters, toaster ovens, mixers, and/or the like), doorways and windows (e.g., front door(s), patio door(s), room doors, closet doors, bathroom doors, garage doors, windows, etc.), pathways (e.g., driveways, walkways, sidewalks, patio, steps, porch, garden paths, etc.), vehicles, grounds-keeping equipment (e.g., sprinkler system (including, without limitation, sprinkler heads, sprinkler lines, sprinkler switches, sprinkler controllers, lawn mower, snow blower, fertilizer distributors, grounds-keeping drones, and/or the like)), lawn and plant life (including, but not limited to, lawn, trees, bushes, shrubs, flowers, plants, and/or the like that may be planted indoors or outdoors), control or management nodes (including, without limitation, IoT human interface devices, computing nodes, management nodes, gateway devices, etc.), and/or the like.

According to some embodiments, customer premises 300 might further comprise a plurality of first motion sensors 310 mounted in one or more doorways 315 of the customer premises structure 305, a plurality of second motion sensors 320 mounted on one or more walls of the customer premises structure 305, one or more user devices 325, one or more speakers 330, and a control or management node 340 (also referred to herein as “computing system”), or the like. In some cases, the first motion sensors 310 might be mounted three-quarters (¾) of the way up a frame of the doorways 315 from the floor of the customer premises structure 305. The first motion sensors 310 (and perhaps also the second motion sensors 320) might utilize gradients to distinguish between or among individuals or to distinguish humans from animals, assuming there are sufficient physical differences between the individuals.

In some alternative embodiments, the control or management nodes 340 might interact in a machine-to-machine manner with each of at least one of one or more home appliances or fixtures, one or more user or electronic devices, one or more kitchen appliances, one or more grounds-keeping equipment, and/or the like, which might be IoT-capable versions of such devices and systems, and/or with IoT-capable sensors that might be embodied within one or more of these devices or systems or embodied in stand-alone housings.

The first motion sensor(s) 310 or the second motion sensor(s) 320, the individual(s) 335, the user device(s) 325, and the speaker(s) 330 of FIG. 3 might be otherwise similar, if not identical, to the first motion sensor(s) 115 (and in some cases, also the computing system 105a), the individual(s) 120, the user device(s) 130, and the speaker(s) 135a-135n, respectively, of system 100 of FIG. 1, or the like, and the descriptions of these components of system 100 are applicable to the corresponding components of FIG. 3, respectively.

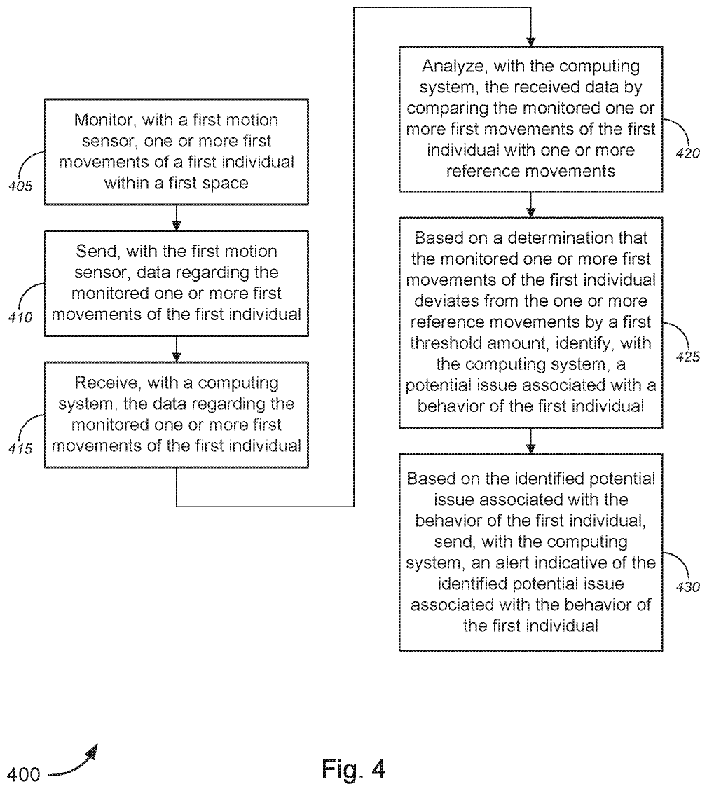

FIG. 4 is a flow diagram illustrating a method 400 for implementing AI-enabled system for providing care to elders, children, or patients, in accordance with various embodiments.

While the techniques and procedures are depicted and/or described in a certain order for purposes of illustration, it should be appreciated that certain procedures may be reordered and/or omitted within the scope of various embodiments. Moreover, while the method 400 illustrated by FIG. 4 can be implemented by or with (and, in some cases, are described below with respect to) the systems or customer premises 100, 200, and 300 of FIGS. 1, 2, and 3, respectively (or components thereof), such methods may also be implemented using any suitable hardware (or software) implementation. Similarly, while each of the systems or customer premises 100, 200, and 300 of FIGS. 1, 2, and 3, respectively (or components thereof), can operate according to the method 400 illustrated by FIG. 4 (e.g., by executing instructions embodied on a computer readable medium), the systems or customer premises 100, 200, and 300 of FIGS. 1, 2, and 3 can each also operate according to other modes of operation and/or perform other suitable procedures.

In the non-limiting embodiment of FIG. 4, method 400, at block 405, might comprise monitoring, with a first motion sensor, one or more first movements of a first individual within a first space. At block 410, method 400 might comprise sending, with the first motion sensor, data regarding the monitored one or more first movements of the first individual. Method 400 might further comprise receiving, with a computing system, the data regarding the monitored one or more first movements of the first individual (block 415); and analyzing, with the computing system, the received data by comparing the monitored one or more first movements of the first individual with one or more reference movements (block 420).

Method 400 might further comprise, based on a determination that the monitored one or more first movements of the first individual deviates from the one or more reference movements by a first threshold amount, identifying, with the computing system, a potential issue associated with a behavior of the first individual (block 425), and, based on the identified potential issue associated with the behavior of the first individual, sending, with the computing system, an alert indicative of the identified potential issue associated with the behavior of the first individual (block 430).

In some embodiments, the computing system might include, without limitation, at least one of an open source IoT platform, a microcontroller, a server computer over a network, a cloud-based computing system over a network, or a distributed computing system, and/or the like. In some cases, the first motion sensor might include, but is not limited to, one of a wired motion sensor, a wireless motion sensor, a wired infrared (“IR”) sensor, a wireless IR sensor, a wired passive infrared (“PIR”) sensor, or a wireless PR sensor, and/or the like, where the first motion sensor might be a non-image capture sensor or a non-video capture sensor. In this manner, privacy of the individual(s) may be maintained while monitoring may be implemented to provide care to the individual(s). In some instances, the first motion sensor might output electromagnetic radiation that bounces off objects or walls within the first space to capture the one or more first movements of the first individual. According to some embodiments, the first space might include, without limitation, one of a room in a customer premises, a room in a school, a room in a daycare center, a room in a clinic, a room in an urgent care facility, a room in an elder care facility, or a room in a hospital, and/or the like. In some instances, the one or more reference movements might be representative of at least one of normal human behavior or normal behavior for the first individual.

Merely by way of example, in some cases, the alert indicative of the identified potential issue might comprise one of an actionable alert or a critical alert, and/or the like. The actionable alert might include, without limitation, one or more first actions for inquiring about or checking a status of the first individual, while the critical alert might include, but is not limited to, one or more second actions for actively aiding the first individual due to an urgent status of the first individual.

According to some embodiments, sending the alert indicative of the identified potential issue associated with the behavior of the first individual might comprise sending, with the computing system, an alert indicative of the identified potential issue associated with the behavior of the first individual in the form of at least one of a voice interaction with the first individual via one or more first speakers, a text message interaction with the first individual via a user interface of a first user device associated with the first individual, a chat interaction with the first individual via a user interface of a second user device associated with the first individual, an automated voice interaction with the first individual via a third user device associated with the first individual, or an e-mail exchange with the first individual via a fourth user device associated with the first individual, and/or the like. In some embodiments, the first individual might include, but is not limited to, one of an elder, a child, or a patient, and/or the like.

Alternatively, or additionally, sending the alert indicative of the identified potential issue associated with the behavior of the first individual might comprise sending, with the computing system, an alert indicative of the identified potential issue associated with the behavior of the first individual in the form of at least one of a voice interaction with a caretaker of the first individual via one or more second speakers, a text message interaction with the caretaker of the first individual via a user interface of a first user device associated with the caretaker, a chat interaction with the caretaker of the first individual via a user interface of a second user device associated with the caretaker, an automated voice interaction with the caretaker of the first individual via a third user device associated with the caretaker, an e-mail exchange with the caretaker of the first individual via a fourth user device associated with the caretaker, a voice interaction with a medical professional providing medical care to the first individual via one or more third speakers, a text message interaction with the medical professional providing medical care to the first individual via a user interface of a first user device associated with the medical professional, a chat interaction with the medical professional providing medical care to the first individual via a user interface of a second user device associated with the medical professional, an automated voice interaction with the medical professional providing medical care to the first individual via a third user device associated with the medical professional, or an e-mail exchange with the medical professional providing medical care to the first individual via a fourth user device associated with the medical professional, and/or the like. In some embodiments, the caretaker might include, without limitation, one of a nurse, an elder care facility staff member, or a family member of the first individual, and/or the like. According to some embodiments, the medical professional might include, but is not limited to, one of a doctor, a physician's assistant, a nurse, a midwife, a pharmacist, a surgeon, psychiatrist, a psychologist, a chiropractor, or a dentist, and/or the like.

In some embodiments, at least one of the data regarding the monitored one or more first movements of the first individual or data regarding the one or more reference movements might be stored in and accessible from a database. According to some embodiments, the database might include, without limitation, at least one of a local database, a network database accessible by the computing system via a network, or a cloud database, and/or the like.

Exemplary System and Hardware Implementation

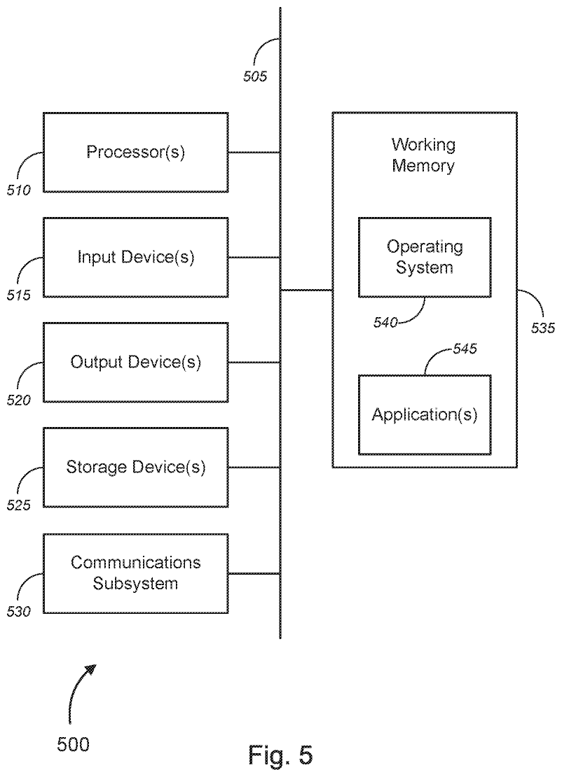

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., computing systems 105a, 105b, and 205, first motion sensor(s) 115, 240, 310, and 320, user devices 130, 255, and 325, and server(s) 140, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., computing systems 105a, 105b, and 205, first motion sensor(s) 115, 240, 310, and 320, user devices 130, 255, and 325, and server(s) 140, etc.), described above with respect to FIGS. 1-4—is shown comprising hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further comprise a working memory 535, which can include a RAM or ROM device, as described above.

The computer or hardware system 500 also may comprise software elements, shown as being currently located within the working memory 535, including an operating system 540, device drivers, executable libraries, and/or other code, such as one or more application programs 545, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that comprise the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

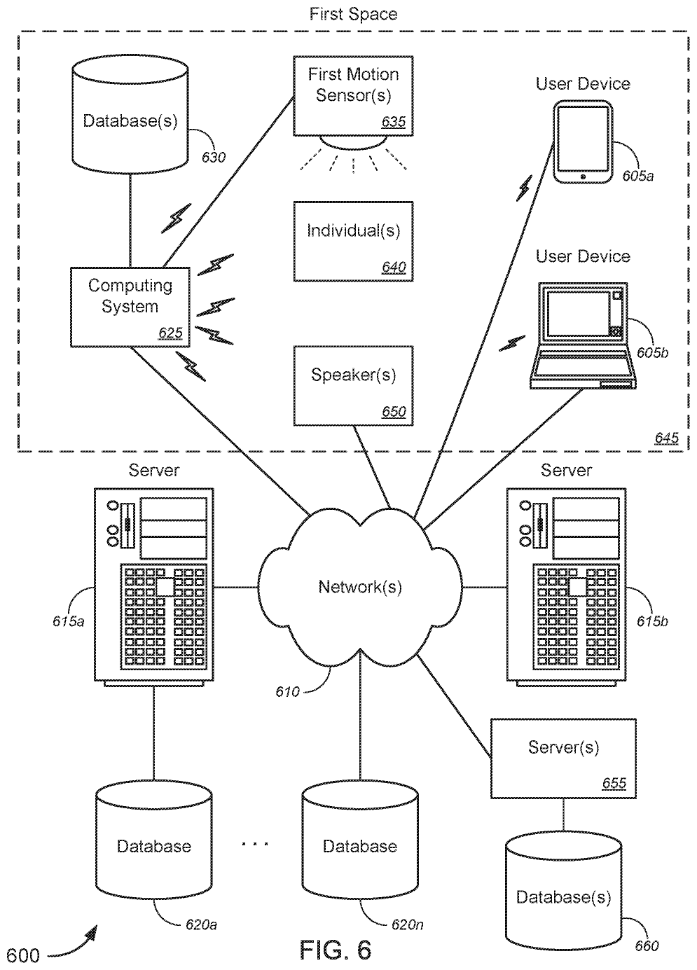

As noted above, a set of embodiments comprises methods and systems for implementing monitoring of and provisioning of care to individuals, and, more particularly, to methods, systems, and apparatuses for implementing artificial intelligence (AI)-enabled system for providing care to elders, children, or patients. FIG. 6 illustrates a schematic diagram of a system 600 that can be used in accordance with one set of embodiments. The system 600 can include one or more user computers, user devices, or customer devices 605. A user computer, user device, or customer device 605 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX™ or UNIX-like operating systems. A user computer, user device, or customer device 605 can also have any of a variety of applications, including one or more applications configured to perform methods provided by various embodiments (as described above, for example), as well as one or more office applications, database client and/or server applications, and/or web browser applications. Alternatively, a user computer, user device, or customer device 605 can be any other electronic device, such as a thin-client computer, Internet-enabled mobile telephone, and/or personal digital assistant, capable of communicating via a network (e.g., the network(s) 610 described below) and/or of displaying and navigating web pages or other types of electronic documents. Although the exemplary system 600 is shown with two user computers, user devices, or customer devices 605, any number of user computers, user devices, or customer devices can be supported.

Certain embodiments operate in a networked environment, which can include a network(s) 610. The network(s) 610 can be any type of network familiar to those skilled in the art that can support data communications using any of a variety of commercially-available (and/or free or proprietary) protocols, including, without limitation, TCP/IP, SNA™, IPX™, AppleTalk™, and the like. Merely by way of example, the network(s) 610 (similar to network(s) 150 and/or 295 of FIG. 1 or 2, or the like) can each include a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 615. Each of the server computers 615 may be configured with an operating system, including, without limitation, any of those discussed above, as well as any commercially (or freely) available server operating systems. Each of the servers 615 may also be running one or more applications, which can be configured to provide services to one or more clients 605 and/or other servers 615.

Merely by way of example, one of the servers 615 might be a data server, a web server, a cloud computing device(s), or the like, as described above. The data server might include (or be in communication with) a web server, which can be used, merely by way of example, to process requests for web pages or other electronic documents from user computers 605. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 605 to perform methods of the invention.

The server computers 615, in some embodiments, might include one or more application servers, which can be configured with one or more applications accessible by a client running on one or more of the client computers 605 and/or other servers 615. Merely by way of example, the server(s) 615 can be one or more general purpose computers capable of executing programs or scripts in response to the user computers 605 and/or other servers 615, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer, user device, or customer device 605 and/or another server 615. In some embodiments, an application server can perform one or more of the processes for implementing monitoring of and provisioning of care to individuals, and, more particularly, to methods, systems, and apparatuses for implementing AI-enabled system for providing care to elders, children, or patients, as described in detail above. Data provided by an application server may be formatted as one or more web pages (comprising HTML, JavaScript, etc., for example) and/or may be forwarded to a user computer 605 via a web server (as described above, for example). Similarly, a web server might receive web page requests and/or input data from a user computer 605 and/or forward the web page requests and/or input data to an application server. In some cases, a web server may be integrated with an application server.

In accordance with further embodiments, one or more servers 615 can function as a file server and/or can include one or more of the files (e.g., application code, data files, etc.) necessary to implement various disclosed methods, incorporated by an application running on a user computer 605 and/or another server 615. Alternatively, as those skilled in the art will appreciate, a file server can include all necessary files, allowing such an application to be invoked remotely by a user computer, user device, or customer device 605 and/or server 615.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620a-620n (collectively, “databases 620”). The location of each of the databases 620 is discretionary: merely by way of example, a database 620a might reside on a storage medium local to (and/or resident in) a server 615a (and/or a user computer, user device, or customer device 605). Alternatively, a database 620n can be remote from any or all of the computers 605, 615, so long as it can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605, 615 can be stored locally on the respective computer and/or remotely, as appropriate.) In one set of embodiments, the database 620 can be a relational database, such as an Oracle database, that is adapted to store, update, and retrieve data in response to SQL-formatted commands. The database might be controlled and/or maintained by a database server, as described above, for example.

According to some embodiments, system 600 might further comprise a computing system 625 (similar to computing systems 105a, 105b, and 205 of FIGS. 1 and 2, or the like), database(s) 630 (similar to databases 110a, 110b, and 290 of FIGS. 1 and 2, or the like), one or more first motion sensors 635 (similar to first motion sensors 115, 240, 310, and 320 of FIGS. 1-3, or the like) monitoring movements of an individual(s) 640 (similar to individuals 120, 245, and 335 of FIGS. 1-3, or the like), the computing system 625, the database(s) 630, the one or more first motion sensors 635, and the individual(s) 640 being located within a first space 645 (similar to first spaces 125, 250, and 305 of FIGS. 1-3, or the like). In some embodiments, system 600 might further comprise one or more speakers 650 (similar to speakers 135a-135n, 275, 280, and 330 of FIGS. 1-3, or the like), and one or more servers 655 (similar to server(s) 140 of FIG. 1, or the like) and corresponding database(s) 660 (similar to database(s) 145 of FIG. 1, or the like).

In operation, the first motion sensor(s) 635 might monitor one or more first movements of the individual(s) 640 within the first space 645. The first motion sensor(s) 635 might send data regarding the monitored one or more first movements of the individual(s) 640. In some embodiments, at least one of the computing system 625 and/or the servers 615a, 615b, and/or 655 (collectively, “computing system” or the like) might receive the data regarding the monitored one or more first movements of the individual(s) 640. The computing system might analyze the received data by comparing the monitored one or more first movements of the individual(s) 640 with one or more reference movements. Based on a determination that the monitored one or more first movements of the individual(s) 640 deviates from the one or more reference movements by a first threshold amount, the computing system might identify a potential issue associated with a behavior of the individual(s) 640. Based on the identified potential issue associated with the behavior of the individual(s) 640, the computing system might send an alert indicative of the identified potential issue associated with the behavior of the individual(s) 640.

In some embodiments, the computing system might include, without limitation, an open source IoT platform, a microcontroller, a server computer over a network (e.g., network(s) 610, or the like), a cloud-based computing system over a network (e.g., network(s) 610, or the like), or a distributed computing system, and/or the like. In some cases, the first motion sensor 635 might include, but is not limited to, one of a wired motion sensor, a wireless motion sensor, a wired infrared (“IR”) sensor, a wireless IR sensor, a wired passive infrared (“PIR”) sensor, or a wireless PIR sensor, and/or the like, where the first motion sensor(s) 635 might be a non-image capture sensor or a non-video capture sensor. In this manner, privacy of the individual(s) 640 may be maintained while monitoring may be implemented to provide care to the individual(s) 640. In some instances, the first motion sensor(s) 635 might output electromagnetic radiation (e.g., IR light, or the like) that bounces off objects or walls within the first space 645 to capture the one or more first movements of the individual(s) 640. According to some embodiments, the first space 645 might include, without limitation, one of a room in a customer premises, a room in a school, a room in a daycare center, a room in a clinic, a room in an urgent care facility, a room in an elder care facility, or a room in a hospital, and/or the like. In some instances, the one or more reference movements might be representative of at least one of normal human behavior or normal behavior for the individual(s) 640.

Merely by way of example, in some cases, the alert indicative of the identified potential issue might comprise one of an actionable alert or a critical alert, and/or the like. The actionable alert might include, without limitation, one or more first actions for inquiring about or checking a status of the individual(s) 640, while the critical alert might include, but is not limited to, one or more second actions for actively aiding the individual(s) 640 due to an urgent status of the individual(s) 640.

According to some embodiments, sending the alert indicative of the identified potential issue associated with the behavior of the individual(s) 640 might comprise sending, with the computing system, an alert indicative of the identified potential issue associated with the behavior of the individual(s) 640 in the form of at least one of a voice interaction with the individual(s) 640 via one or more first speakers 650, a text message interaction with the individual(s) 640 via a user interface of a first user device 605a or 605b associated with the individual(s) 640, a chat interaction with the individual(s) 640 via a user interface of a second user device 605a or 605b associated with the individual(s) 640, an automated voice interaction with the individual(s) 640 via a third user device 605a or 605b associated with the individual(s) 640, or an e-mail exchange with the individual(s) 640 via a fourth user device 605a or 605b associated with the individual(s) 640, and/or the like. In some embodiments, the individual(s) 640 might include, but is not limited to, one of an elder, a child, or a patient, and/or the like.

Alternatively, or additionally, sending the alert indicative of the identified potential issue associated with the behavior of the individual(s) 640 might comprise sending, with the computing system, an alert indicative of the identified potential issue associated with the behavior of the individual(s) 640 in the form of at least one of a voice interaction with a caretaker of the individual(s) 640 via one or more second speakers, a text message interaction with the caretaker of the individual(s) 640 via a user interface of a first user device associated with the caretaker, a chat interaction with the caretaker of the individual(s) 640 via a user interface of a second user device associated with the caretaker, an automated voice interaction with the caretaker of the individual(s) 640 via a third user device associated with the caretaker, an e-mail exchange with the caretaker of the individual(s) 640 via a fourth user device associated with the caretaker, a voice interaction with a medical professional providing medical care to the individual(s) 640 via one or more third speakers, a text message interaction with the medical professional providing medical care to the individual(s) 640 via a user interface of a first user device associated with the medical professional, a chat interaction with the medical professional providing medical care to the individual(s) 640 via a user interface of a second user device associated with the medical professional, an automated voice interaction with the medical professional providing medical care to the individual(s) 640 via a third user device associated with the medical professional, or an e-mail exchange with the medical professional providing medical care to the individual(s) 640 via a fourth user device associated with the medical professional, and/or the like. In some embodiments, the caretaker might include, without limitation, one of a nurse, an elder care facility staff member, or a family member of the individual(s) 640, and/or the like. According to some embodiments, the medical professional might include, but is not limited to, one of a doctor, a physician's assistant, a nurse, a midwife, a pharmacist, a surgeon, psychiatrist, a psychologist, a chiropractor, or a dentist, and/or the like.

In some embodiments, at least one of the data regarding the monitored one or more first movements of the individual(s) 640 or data regarding the one or more reference movements might be stored in and accessible from a database (e.g., databases 620a-620n, 630, and/or 660, or the like). According to some embodiments, the database might include, without limitation, at least one of a local database 630, a network database 620a-620n or 660 accessible by the computing system via a network, or a cloud database 620a-620n or 660, and/or the like.

These and other functions of the system 600 (and its components) are described in greater detail above with respect to FIGS. 1-4.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

1. A method, comprising:
monitoring, with a first motion sensor, one or more first movements of a first individual within a first space;
sending, with the first motion sensor, data regarding the monitored one or more first movements of the first individual;
receiving, with a computing system, the data regarding the monitored one or more first movements of the first individual;
analyzing, with the computing system, the received data by comparing the monitored one or more first movements of the first individual with one or more reference movements;
determining, with the computing system, whether the monitored one or more first movements of the first individual deviates from the one or more reference movements by a first threshold amount or a second threshold amount, wherein the first threshold amount is indicative of an actionable deviation, and wherein the second threshold amount is indicative of a critical deviation, and wherein the critical deviation deviates more than the actionable deviation;
based on a determination that the monitored one or more first movements of the first individual deviates from the one or more reference movements by the first threshold amount or the second threshold amount, identifying, with the computing system, a potential issue associated with a behavior of the first individual; and
based on the identified potential issue associated with the behavior of the first individual, sending, with the computing system, an alert indicative of the identified potential issue associated with the behavior of the first individual, wherein the alert that is sent changes based on whether the monitored one or more first movements of the first individual are indicative of the actionable deviation or the critical deviation.

2. The method of claim 1, wherein the computing system comprises at least one of an open source IoT platform, a microcontroller, a server computer over a network, a cloud-based computing system over a network, or a distributed computing system.

3. The method of claim 1, wherein the first motion sensor comprises one of a wired motion sensor, a wireless motion sensor, a wired infrared (“IR”) sensor, a wireless IR sensor, a wired passive infrared (“PIR”) sensor, or a wireless PIR sensor, wherein the first motion sensor is a non-image capture sensor or a non-video capture sensor.

4. The method of claim 1, wherein the first motion sensor outputs electromagnetic radiation that bounces off objects or walls within the first space to capture the one or more first movements of the first individual.

5. The method of claim 1, wherein the first space comprises one of a room in a customer premises, a room in a school, a room in a daycare center, a room in a clinic, a room in an urgent care facility, a room in an elder care facility, or a room in a hospital.

6. The method of claim 1, wherein the one or more reference movements are representative of at least one of normal human behavior or normal behavior for the first individual.

7. The method of claim 1, wherein the alert indicative of the identified potential issue comprises one of an actionable alert or a critical alert, wherein the actionable alert comprises one or more first actions for inquiring about or checking a status of the first individual, wherein the critical alert comprises one or more second actions for actively aiding the first individual due to an urgent status of the first individual.

8. The method of claim 1, wherein sending the alert indicative of the identified potential issue associated with the behavior of the first individual comprises sending, with the computing system, an alert indicative of the identified potential issue associated with the behavior of the first individual in the form of at least one of a voice interaction with the first individual via one or more first speakers, a text message interaction with the first individual via a user interface of a first user device associated with the first individual, a chat interaction with the first individual via a user interface of a second user device associated with the first individual, an automated voice interaction with the first individual via a third user device associated with the first individual, or an e-mail exchange with the first individual via a fourth user device associated with the first individual.

9. The method of claim 1, wherein sending the alert indicative of the identified potential issue associated with the behavior of the first individual comprises sending, with the computing system, an alert indicative of the identified potential issue associated with the behavior of the first individual in the form of at least one of a voice interaction with a caretaker of the first individual via one or more second speakers, a text message interaction with the caretaker of the first individual via a user interface of a first user device associated with the caretaker, a chat interaction with the caretaker of the first individual via a user interface of a second user device associated with the caretaker, an automated voice interaction with the caretaker of the first individual via a third user device associated with the caretaker, an e-mail exchange with the caretaker of the first individual via a fourth user device associated with the caretaker, a voice interaction with a medical professional providing medical care to the first individual via one or more third speakers, a text message interaction with the medical professional providing medical care to the first individual via a user interface of a first user device associated with the medical professional, a chat interaction with the medical professional providing medical care to the first individual via a user interface of a second user device associated with the medical professional, an automated voice interaction with the medical professional providing medical care to the first individual via a third user device associated with the medical professional, or an e-mail exchange with the medical professional providing medical care to the first individual via a fourth user device associated with the medical professional.

10. The method of claim 1, wherein at least one of the data regarding the monitored one or more first movements of the first individual or data regarding the one or more reference movements are stored in and accessible from a database.

11. The method of claim 10, wherein the database comprises at least one of a local database, a network database accessible by the computing system via a network, or a cloud database.

12. An apparatus, comprising:
at least one processor; and
a non-transitory computer readable medium communicatively coupled to the at least one processor, the non-transitory computer readable medium having stored thereon computer software comprising a set of instructions that, when executed by the at least one processor, causes the apparatus to:
receive, from a first motion sensor, data regarding monitored one or more first movements of a first individual within a first space;
analyze the received data by comparing the monitored one or more first movements of the first individual with one or more reference movements;
determine whether the monitored one or more first movements of the first individual deviates from the one or more reference movements by a first threshold amount or a second threshold amount, wherein the first threshold amount is indicative of an actionable deviation, and wherein the second threshold amount is indicative of a critical deviation, and wherein the critical deviation deviates more than the actionable deviation;
based on a determination that the monitored one or more first movements of the first individual deviates from the one or more reference movements by the first threshold amount or the second threshold amount, identify a potential issue associated with a behavior of the first individual; and
based on the identified potential issue associated with the behavior of the first individual, send an alert indicative of the identified potential issue associated with the behavior of the first individual, wherein the alert that is sent changes based on whether the monitored one or more first movements of the first individual are indicative of the actionable deviation or the critical deviation.

13. The apparatus of claim 12, wherein the first motion sensor comprises one of a wired motion sensor, a wireless motion sensor, a wired infrared (“IR”) sensor, a wireless IR sensor, a wired passive infrared (“PIR”) sensor, or a wireless PIR sensor, wherein the first motion sensor is a non-image capture sensor or a non-video capture sensor.

14. The apparatus of claim 12, wherein the first space comprises one of a room in a customer premises, a room in a school, a room in a daycare center, a room in a clinic, a room in an urgent care facility, a room in an elder care facility, or a room in a hospital.

15. The apparatus of claim 12, wherein the one or more reference movements are representative of at least one of normal human behavior or normal behavior for the first individual.

16. The apparatus of claim 12, wherein the alert indicative of the identified potential issue comprises one of an actionable alert or a critical alert, wherein the actionable alert comprises one or more first actions for inquiring about or checking a status of the first individual, wherein the critical alert comprises one or more second actions for actively aiding the first individual due to an urgent status of the first individual.

17. The apparatus of claim 12, wherein at least one of the data regarding the monitored one or more first movements of the first individual or data regarding the one or more reference movements are stored in and accessible from a database.

18. A system, comprising:
a first motion sensor; and
a computing system, comprising:
at least one processor; and
a non-transitory computer readable medium communicatively coupled to the at least one processor, the non-transitory computer readable medium having stored thereon computer software comprising a set of instructions that, when executed by the at least one processor, causes the computing system to:
receive, from the first motion sensor, data regarding monitored one or more first movements of a first individual within a first space;
analyze the received data by comparing the monitored one or more first movements of the first individual with one or more reference movements;
determine whether the monitored one or more first movements of the first individual deviates from the one or more reference movements by a first threshold amount or a second threshold amount, wherein the first threshold amount is indicative of an actionable deviation, and wherein the second threshold amount is indicative of a critical deviation, and wherein the critical deviation deviates more than the actionable deviation;
based on a determination that the monitored one or more first movements of the first individual deviates from the one or more reference movements by the first threshold amount or the second threshold amount, identify a potential issue associated with a behavior of the first individual; and
based on the identified potential issue associated with the behavior of the first individual, send an alert indicative of the identified potential issue associated with the behavior of the first individual, wherein the alert that is sent changes based on whether the monitored one or more first movements of the first individual are indicative of the actionable deviation or the critical deviation.

19. The system of claim 18, wherein the computing system comprises at least one of an open source IoT platform, a microcontroller, a server computer over a network, a cloud-based computing system over a network, or a distributed computing system.

20. The system of claim 18, wherein the first motion sensor comprises one of a wired motion sensor, a wireless motion sensor, a wired infrared (“IR”) sensor, a wireless IR sensor, a wired passive infrared (“PIR”) sensor, or a wireless PIR sensor, wherein the first motion sensor is a non-image capture sensor or a non-video capture sensor.
